(19) United States
(12) Patent Application Publication
(10) Pub. No.: US 2006/0150918 A1
(43) Pub. Date: Jul. 13, 2006

(54) Pet amusement device

(76) Inventor: Rick Rowe, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/032,722

(22) Filed: Jan. 10, 2005

(51) Int. Cl. A01K 29/00

(52) U.S. Cl. 119/707

(57) ABSTRACT

A pet entertainment toy is capable of motion. The toy is comprised of a propulsion system, such as a frame rollably supported by one or more driven wheels. An animal likeness is preferably connected to the frame. In one embodiment, the likeness is animated for movement and may be configured to generate sounds. A remote control is used to control the toy, such as to cause the toy to move forward, in reverse, to stop, and to turn, and in one embodiment, to activate the animal likeness animation. The toy is configured for high speed movement over long distances and over a wide range of surface. The toys animal likeness is enticing to a pet in engaging in hunting and tracking of the toy.

### FIELD OF THE INVENTION

The present invention relates to pet entertainment or amusement devices, and particularly to a motorized pet toy.

### BACKGROUND OF THE INVENTION

A variety of toys have been created for amusing and entertaining pets. For example, these toys include rubber bones for chewing, ropes for tugging and toys employing squeakers.

Pets, especially including dogs and cats, find great amusement in chasing things. For example, dogs like to chase and retrieve sticks and balls which their master may throw. Cats like to chase yarn and small toys which one drags along the floor.

These toys, however, do not provide a great challenge to the pet and the owner often finds playing with their pet with these toys very tiring. For example, while a dog may seemingly endlessly chase a ball, the owner may quickly tire of throwing the ball and then attempting to retrieve it from the dog. Likewise, one quickly grows tired of dragging string about the floor to entertain a cat.

Generally, the pet's play activities are associated with their instinctive hunting skills. Thus, a dog enjoys chasing a ball as part of the dog's instinct to chase and kill or retrieve prey. Likewise, a cat's chasing of a string or small toy is a product of its hunting instinct. Thus, the more the amusement activity simulates the actual instinctive act, the more fun it is for the pet. Thus, some toys have been created which have the appearance of a mouse, bird or the like.

A pet amusement or entertainment device which is fun for the pet and the owner is desired.

### SUMMARY OF THE INVENTION

The invention is a pet amusement or entertainment device. In one embodiment, the device is a self-propelled, remotely controllable toy. The toy preferably includes a frame which is rollably supported for movement over a variety of surfaces. Means, such as one or motors, are configured to propel the toy.

The toy also includes or is configured as an animal likeness. In one embodiment, the likeness is connected to the frame. The likeness maybe animated so as to simulate the movement and nature of the animal which is being represented.

The toy provides excitement to the pet and is easy for the operator to use. The toy can travel over long distances and over a variety of surfaces, providing the opportunity for a pet to chase it. The likeness creates substantial pet interest, including by drawing upon the pet's hunting instincts.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a pet toy in accordance with the invention;

FIG. 2 is an exploded view of the pet toy illustrated in FIG. 1; and

FIG. 3 is a block diagram of various components of the toy illustrated in FIG. 1.

### DETAILED DESCRIPTION OF THE INVENTION

The invention is a pet amusement or entertainment device. In the following description, numerous specific details are set forth in order to provide a more thorough description of the present invention. It will be apparent, however, to one skilled in the art, that the present invention maybe practiced without these specific details. In other instances, well-known features have not been described in detail so as not to obscure the invention.

In general, a pet amusement or entertainment device comprises a self-propelled, remotely controllable toy. Preferably, at least a portion of the toy has the appearance of an animal or other creature.

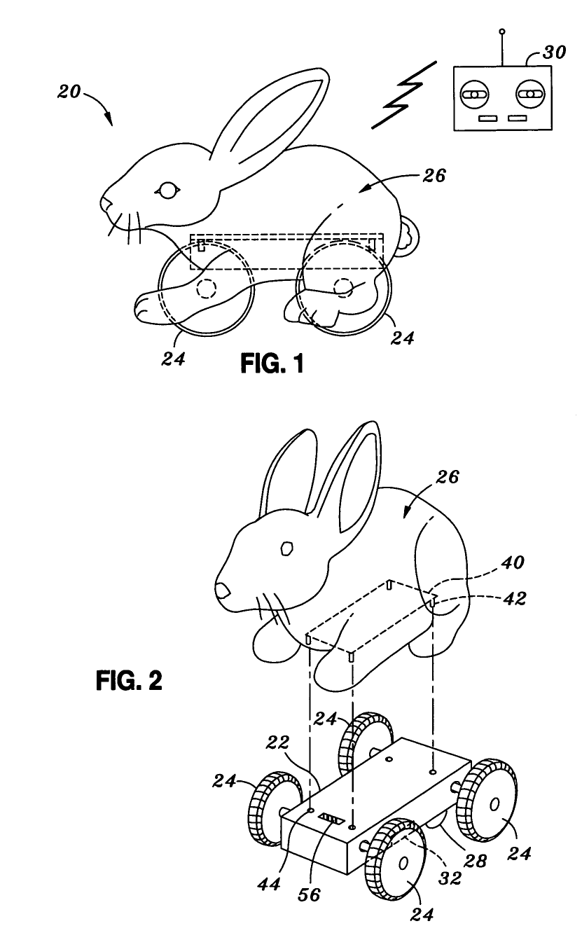

FIG. 1 illustrates a toy 20 in accordance with one embodiment of the invention. Referring to FIG. 2, the toy 20 includes a frame 22 which supports various components of the toy 20. In a preferred embodiment, the toy 20 is rollably supported. As illustrated, a plurality of wheels 24 are mounted to the frame 22 for rotation with respect to the frame. In a preferred embodiment, the toy 20 has four wheels 24 generally arranged in automobile format, with two front wheels and two rear wheels, with two wheels located at each side of the frame 22.

Preferably, the toy 20 is self-propelled or locomotive. Thus, in one embodiment, the toy 20 includes means for driving one or more of the wheels. In one embodiment, the toy 20 includes one or more motors 28 which are configured to drive one or more of the wheels 24 for propelling the toy. In a preferred embodiment, the one or more motors are electrically powered. The one or more motors 28 may be configured to drive the toy 20 to stop and start the motion of the toy 20, and permit motion in forward and reverse directions.

An electrical source is configured to power the motor(s) in such a configuration. In one embodiment, the electrical source comprises one or more batteries 32, whereby the power source for the motor(s) is portable and may travel with the toy 20. In one embodiment, the battery or batteries 32 may be disconnected from the frame 22. The battery or batteries 32 may be of various types, including rechargeable.

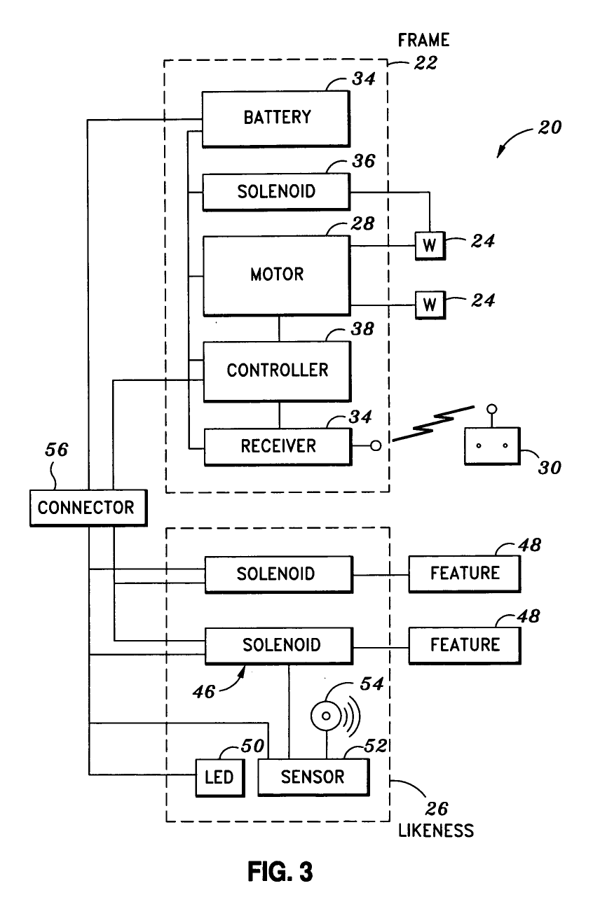

In one embodiment, the one or motors are remotely controllable. Referring to FIG. 3, the toy preferably includes one or more receivers 34 (see FIG. 3). The at least one receiver 34 is configured to receive signals from a remote control 30. Preferably, the receiver 34 is configured to provide an output in response to a signal received from the remote control 30. In one embodiment, the output is provided to a main controller 38 which utilizes the signals to provide discrete outputs to the various components of the toy, such as the motors, for controlling them.

One or more solenoids 36 or other means may be provided for moving one or more of the wheels 24, such as for steering and directing the toy as it moves. The controller 38 may be configured to output a signal to the one or more solenoids 36 for such a purpose.

In a preferred embodiment, at least a portion of the toy 20 has the appearance of an animal. In one embodiment, an animal likeness or representation 26 is associated with the frame 22. The animal likeness 26 preferably may only have the general appearance of an animal or other object. The animal likeness 26 maybe, for example, a rabbit. The rabbit likeness need not exactly duplicate a real rabbit, and may vary in color and size, and need not include all anatomical features. Preferably, however, the animal likeness has some features or characteristics of a rabbit or other animal which is to be represented, such as general shape, simulation of fur or the like.

The animal likeness 26 maybe constructed of a variety of materials. In a preferred embodiment, the animal likeness 26 is constructed of a durable and at least partially pliable material. For example, the animal likeness 26 maybe constructed at least partially of a fabric material. An interior portion of the likeness may be filled with a compressible material, such as foam or other stuffing material.

The animal likeness 26 is preferably connected to the frame 22, either directly or indirectly. In one embodiment, the animal likeness 26 may include a mount or frame 40 which is connected to the frame 22 of the toy 20, such as with one or more fasteners. For example, the animal likeness 26 may include a generally rigid base and that base may be connected to the frame 22 with threaded fasteners.

In another embodiment, the animal likeness 26 maybe disengageable from the frame 22. For example, if a dog were to grasp the animal likeness 26 and attempt to move or lift the toy 20, the likeness 26 maybe configured to disconnect from the frame 22 to prevent the electronics, drive and other elements of the toy 20 from being damaged. For example, the likeness 26 might connect to the frame with flexible pins or tabs 42. Upon being picked up, those tabs maybe configured to flex and disengage corresponding mounting holes 44 in the frame.

In one embodiment, the animal likeness 26 maybe animated. Motors or other means maybe provided for moving one or more portions of the likeness 26. For example, referring to FIG. 3, solenoids 46 maybe configured to move the legs, ears, head or other features 48 of the animal likeness 26. In one embodiment, animation of the likeness 26 maybe initiated by signal from the remote control 30. In another embodiment, the animation may be initiated by other input, such as motion of the toy 20.

In one embodiment, the animal's eyes may include LED's 50 or other lights sources for illuminating them. The likeness 26 may include one or more pressure sensors 52. Those sensors 52 may trigger animation of the likeness 26. In one embodiment, the toy 20 may include a sound generating device 54, such as a speaker. In response to input via a pressure sensor 52, the sound generating device maybe activated. For example, in response to a dog grasping the toy with its jaws, the sound generating device may be configured to output a squeaking noise.

In one embodiment, the likeness 26 may include a “vibration” element which is triggered by a pressure sensor or via remote control. The vibration device is preferably configured to generate a pulsating or shaking movement to the likeness.

The toy 20 may include one or more sensors for detecting obstacles and causing the main controller to automatically change the direction of the toy 20 in order to avoid obstacles. The toy 20 may also be configured to travel set paths or patterns. For example, instead of remotely controlling the movement of the toy 20 in real time, the toy 20 could be programmed or instructed to follow a path or pattern, thus freeing the operator from having to direct the toy.

In one embodiment, various of the animation features of the likeness 26 maybe configured to activate in coordination with other elements of the toy. For example, when the one or more motors 28 are activated to move the toy, animation features of the likeness 26 maybe activated to effect movement of legs of the likeness 26 to simulate hopping or running.

Various of the components of the likeness 26 may require power for their operation. In one embodiment, the likeness 26 could include one or more batteries or other power sources for that purpose. In a preferred embodiment, an electrical plug or contact 56 is associated with the frame 22, as illustrated in FIG. 2. The likeness 26 may include a mating connector (not shown) which engages that plug or contact 56 when the likeness 26 is connected thereto. Preferably, the connection of the connector and plug permits easy disconnection, as when a pet grasps the likeness 26 and disconnection of the likeness 26 from the frame 22 is desired. Referring to FIG. 3, when the likeness 26 is connected to the frame 22 in this manner, an electrical path is established from the batter 34 to the various components of the likeness 26, thus providing power to them.

In one embodiment, the plug and mating connector may include a communication path from the controller 38 to one or more components of the likeness 26, as illustrated in FIG. 3. In this manner, the controller 38 may effect operation of one or more of those components. In a less preferred embodiment, the likeness 26 could include a separate controller and receiver and instructions could directly be received at the likeness and the components of the likeness be independently controlled.

In one embodiment, the animal likeness 26 may house or enclose various components of the toy 20. Such an embodiment of the invention is illustrated in FIG. 1 where the wheels 24 are located substantially within the animal likeness 26, the wheels configured to extend below the likeness 26 for contact with the ground. In this manner, the wheels 24 are not exposed, either distracting from the toy's simulation of an actual animal, or posing a risk of harming a pet who might contact the wheel.

Of course, the size of the toy 20 may vary, including depending upon the animal which is being simulated. In one embodiment, the wheels 24 maybe about 2-6 inches in diameter, be spaced front to back by about 4-8 inches and from side to side by about 4-8 inches. In such an embodiment, the toy 20 is capable of traveling over a wide variety of surface, including outdoor surfaces. In such embodiments, the toy 20 may include such features as multiple wheel drive and wheel suspension to allow the toy to quickly move over rough surfaces. Other configurations may be permitted for indoor use.

The likeness 26 maybe about 3-18 inches long, 3-10 inches wide, and about 3-20 inches tall. Of course, the frame is preferably sized to accommodate the likeness 26. The size of the likeness 26 may depend on a variety of factors. For play with a large dog, the likeness 26 may be larger. For play with a small dog or cat, the likeness may be smaller. As indicated, the total size of the toy 20 may vary depending upon the size of the likeness 26. For example, if the likeness 26 is small, the frame and wheels may be correspondingly small.

In a preferred embodiment, the likeness 26 is of an animal. As indicated, the extend of the likeness may vary. The toy 20 may include a likeness of other objects, however.

The toy 20 may include rotating tracks, skids, or other means for movably supporting it for movement. The toy 20 may have more than four wheels or less than four wheels. The toy 20 may be powered by other means than an electric motor, such as a gas or other burning fuel motor.

The toy 20 maybe configured for other movement. For example, the toy 20 maybe configured to roll or spin. The toy 20 maybe configured to spin by turning all of the wheels. In another embodiment, the toy 20 may include a center or central wheel which is used to effectuate spinning and/or turning of the toy. For example, the outer wheels of the toy 20 may be mounted as caster and simply provide rolling support, while a single central wheel provides propulsion to the toy 20.

In one embodiment, the toy 20 maybe configured so that different likenesses maybe attached thereto. For example, an owner might wish to attach the likeness of a cat when playing with their dog, and the likeness of a mouse when playing with their cat. In the event the likeness is damaged, the owner could also easily replace it without having to replace all of the propulsion mechanisms.

FIG. 3 illustrates but one configuration of a toy 20 of the invention, and other configurations are contemplated. For example, the main controller 38 and receiver 34 maybe combined into a single element, and the components may be arranged in a variety of fashions. The signals or other outputs of the various components may be analog or digital, and signals may be transmitted over wires or fibers or wirelessly.

The toy 20 of the invention has numerous advantages and features. The toy 20 is configured to be self-propelled. Thus, the toy 20 is configured to move, and can thus be chased by pets. Because of the configuration of the toy 20, the toy 20 maybe used in a yard or over a wide variety of surfaces and move at sufficiently high speeds and over sufficient distances to challenge the pet in a real chase. At the same time, because the toy 20 is self-propelled, it takes little or no effort on the part of the pet owner to operate it.

Because the toy 20 includes an animal likeness 26, the toy 20 appeals to the instincts of the pet, causing the pet to desire to chase the toy 20.

The pet owner may control the device using the remote control apparatus 30 causing the toy 20 to move in various directions, such as forward, backward and to start and stop. Other controls may permit the operator to animation of the likeness in order to increase the pet's interest in the toy because of the realistic nature of the likeness through its movement.

Once the pet catches the toy, the pet owner can establish some verbal commands to cause their pet to release the toy from its jaws. The pet owner can then retrieve the device and start the game again. The pet may also be permitted to catch the toy and then bite or chew it, even to the point of destroying the likeness 26. The animal likeness may then be replaced, as described above. In this configuration, the animal is rewarded in its efforts to catch the toy 20, and the owner can cheaply and quickly replace the likeness 26 with one of a variety of likenesses for future use.

It will be understood that the above described arrangements of apparatus and the method there from are merely illustrative of applications of the principles of this invention and many other embodiments and modifications maybe made without departing from the spirit and scope of the invention as defined in the claims.

What is claimed is:

1. A pet amusement device comprising:
a frame;
one or more wheels rollably supporting the frame;
at least one motor in driving relationship with one or more of the wheels;
a power source configured to provide power to the at least one motor;
a receiver configured to receive signals from a remote controller;
a main controller configured to receive signals received by said receiver and to provide an output to at least said at least one motor to operate said motor;
an animal likeness connected to said frame, said animal likeness including at least one animation element; and
a connection between said animation element and said battery and said main controller whereby said animation is activated in response to a signal from said main controller.

2. The pet amusement device in accordance with claim 1 wherein said frame is supported by four wheels.

3. The pet amusement device in accordance with claim 1 wherein said animal likeness is configured to cover at least a portion of said frame.

4. The pet amusement device in accordance with claim 1 wherein at least one of the wheels is steerable.

5. A pet amusement device comprising:
a frame;
one or more wheels rollably supporting the frame;
at least one motor in driving relationship with one or more of the wheels;
a power source providing power to the at least one motor;
a receiver configured to receive signals from a remote controller;
a main controller configured to receive signals received by said receiver and to provide an output to at least said at least one motor to operate said motor;
an animal likeness detachably connected to said frame, said likeness when connected to said frame moving with said frame.

6. The pet amusement device in accordance with claim 5 wherein said animal likeness extends over at least a portion of said frame to obscure said frame.

7. The pet amusement device in accordance with claim 5 wherein said animal likeness includes a fabric material covering a stuffing.

8. The pet amusement device in accordance with claim 5 wherein said at least one motor is configured to drive at least one wheel in a forward and a reverse direction.
